(19) United States
(12) Patent Application Publication
(10) Pub. No.: US 2020/0238267 A1
(43) Pub. Date: Jul. 30, 2020

(54) OXYGEN EVOLUTION ELECTRODE AND DEVICE

(71) Applicant: FUJITSU LIMITED, Kawasaki-shi (JP)

(72) Inventors: John David Baniecki, Zama (JP); Hiroyuki Aso, Atsugi (JP); Yoshihiko Imanaka, Atsugi (JP)

(73) Assignee: FUJITSU LIMITED, Kawasaki-shi (JP)

(21) Appl. No.: 16/720,722

(22) Filed: Dec. 19, 2019

(30) Foreign Application Priority Data
Jan. 29, 2019 (JP) 2019-013186

(51) Int. Cl. B01J 35/00; B01J 23/00; B01J 23/14; B01J 23/75

(52) U.S. Cl. CPC B01J 35/004; B01J 23/75; B01J 23/14; B01J 23/002

(57) ABSTRACT

An oxygen evolution device comprises an oxygen evolution electrode and an counter electrode. The oxygen evolution electrode includes: a photocatalyst layer that is formed of a perovskite-type oxide containing at least cobalt (Co), lanthanum (La), and oxygen (O) and that is located at an uppermost layer; a support body that includes at least a layer inside which a depletion layer is formed, and that supports the photocatalyst layer; and a perovskite-type tin compound buffer layer that is degenerately doped n-type and that is disposed between the photocatalyst layer and the support body.

### CROSS-REFERENCE TO RELATED APPLICATION

This application is based upon and claims the benefit of priority of the prior Japanese Patent Application No. 2019-13186, filed on Jan. 29, 2019, the entire contents of which are incorporated herein by reference.

### FIELD

The embodiments discussed herein are related to an oxygen evolution electrode and an oxygen evolution device.

### BACKGROUND

Currently, global interest in developing environmentally friendly and sustainable new energy is attracted. One approach is to generate fuel from water, carbon dioxide, and sunlight, by mimicking photosynthesis. Water splitting by a photocatalyst is an important reaction in a process of converting water to fuel such as hydrogen. Although generation of oxygen is a half-reaction of a water splitting process (oxidation-reduction reaction), the generation of oxygen is considered to be rate-limiting of an electrochemical reaction because the generation of oxygen involves generation of four electrons (e⁻) and four protons (H⁺). Materials or device structures that are highly active in oxygen evolution reaction and may efficiently convert a visible light photon into an electron-hole pair to promote an electrochemical (oxidation-reduction) reaction are desired.

As a photocatalyst, a “co-catalyst” structure in which a photocatalyst thin film for an oxygen evolution reaction (OER) is laminated over a light absorbing layer is being adopted. In a case of a silicon (Si) photoanode, noble metals such as Ir and Ru which are highly active for OER are used as a photocatalyst in many cases. There is a desire for a material that is less expensive than noble metal catalysts, that has activity at a level equivalent to or higher than noble metals, and that is environmentally friendly. As such a material, an oxide-based photocatalyst is expected.

Japanese Laid-open Patent Publication No. 562-161975 and No. 2003-47859 are examples of related art.

The inventors have found that while a photocatalyst of a noble metal maintains its activity in a very thin layer, performance of an OER catalyst of an oxide having a perovskite structure is deteriorated when an ultra-thin film approaches its limit. The OER catalyst is desirably a layer as thin as possible from a viewpoint of minimizing light absorption at a surface of a photocatalyst and shortening a carrier transportation distance to a solid-liquid interface, but there is a problem in terms of the catalytic performance when OER activity is impaired as a film thickness becomes thinner.

It is an object of the present disclosure to provide an oxygen evolution electrode that enables an oxide-based photocatalyst to be a thin film and enables OER activity to be high at the same time, and to provide an oxygen evolution device using the same.

### SUMMARY

According to an aspect of the embodiments, an oxygen evolution electrode includes: a photocatalyst layer that is formed of a perovskite-type oxide containing at least cobalt (Co), lanthanum (La), and oxygen (O) and that is located at an uppermost layer; a support body that includes at least a layer inside which a depletion layer is formed, and that supports the photocatalyst layer; and a perovskite-type tin compound buffer layer that is degenerately doped n-type and that is disposed between the photocatalyst layer and the support body.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a schematic diagram of an oxygen evolution device to which the present disclosure is applied;

FIG. 2 is a diagram illustrating an example of an oxygen evolution electrode to be used in an oxygen evolution device according to a first embodiment;

FIG. 3 is a schematic diagram of a sample for measuring a change in OER activity when a photocatalyst layer is thinned in the configuration illustrated in FIG. 2;

FIG. 4 is a diagram illustrating measurement results of the OER activity;

FIG. 5 is a transmission electron microscopy (TEM) image when a photocatalyst layer is directly formed on SrTiO to which 1 wt % of Nb is added (appropriately, to be referred to as “NSTO”);

FIG. 6 is an atomic force microscopy (AFM) image when a photocatalyst layer is directly formed on NSTO;

FIG. 7 is a schematic diagram of an oxygen evolution electrode according to a second embodiment;

FIG. 8 is a schematic diagram of a sample for measuring a change in OER activity when a photocatalyst layer is thinned in the configuration illustrated in FIG. 7;

FIG. 9 is a diagram illustrating measurement results of the OER activity;

FIG. 10 is a diagram illustrating an effect of buffer layer insertion in the configuration illustrated in FIG. 7;

FIG. 11 is a diagram illustrating series resistance as a function of a film thickness of a photocatalyst layer;

FIG. 12 is a schematic diagram of a variation of an oxygen evolution electrode according to a third embodiment;

FIG. 13 is a diagram illustrating a range of a film thickness of an optimum buffer layer in the configuration illustrated in FIG. 12;

FIG. 14 is a schematic diagram of the sample used in the measurement in FIG. 12;

FIG. 15 is an AFM image when a photocatalyst layer is formed over the buffer layer in the configuration illustrated in FIG. 14;

FIG. 16 is a TEM image when a photocatalyst layer is formed over the buffer layer in the configuration illustrated in FIG. 14;

FIG. 17 is a schematic diagram of an oxygen evolution electrode according to a fourth embodiment; and

FIG. 18 is an AFM image of a photocatalyst layer in the configuration illustrated in FIG. 17.

### DESCRIPTION OF EMBODIMENTS

### First Embodiment

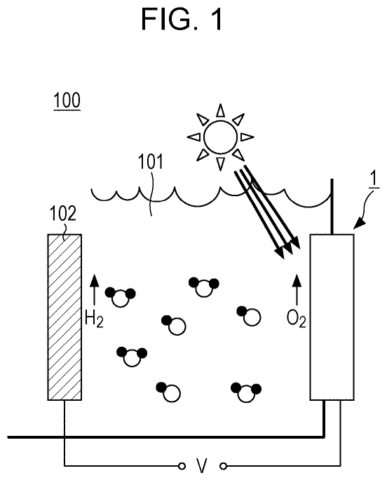

FIG. 1 is a schematic diagram of an oxygen evolution device 100 to which an oxygen evolution electrode of the embodiment is applied. The oxygen evolution device 100 includes a photoelectrode 1, a counter electrode 102, and an electrolytic solution 101 interposed between these electrodes. The electrolytic solution 101 contains water and hydroxide ions (OH⁻) or hydrogen ions (H⁺). White circles contained in the electrolytic solution 101 in the figure represent oxygen, and black circles represent hydrogen.

The oxygen evolution device 100 utilizes a water splitting reaction by a photocatalyst. The photoelectrode 1 is formed, for example, of an n-type oxide semiconductor carried by a conductive layer, and functions as an anode electrode. When light is incident on the photoelectrode 1, electrons and holes are excited by absorption of incident light, and the excited carriers are moved in respective directions. In a case of a photoanode, the holes move to an interface between the photoelectrode 1 and the electrolytic solution 101 to oxidize water and to generate oxygen. The electrons move to the counter electrode 102 to reduce water and to generate hydrogen. At this time, a band edge is bent such that Fermi levels at an interface between the oxide semiconductor and the conductive layer carrying the oxide semiconductor, and at an interface between the oxide semiconductor and the electrolytic solution 101, coincide with each other, the holes move to an interface with the electrolytic solution 101, the electrons move to the conductive layer, and separation of charges is progressed.

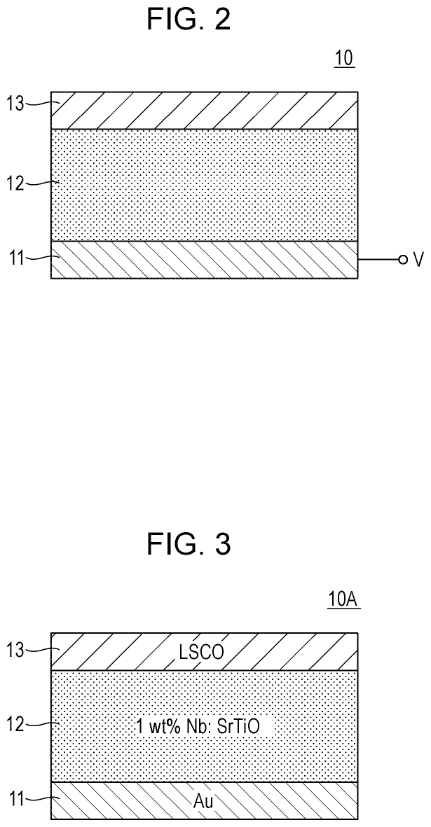

FIG. 2 illustrates an example of a configuration of the oxygen evolution electrode 10 as an example of the photoelectrode 1 to be used in the oxygen evolution device 100. The oxygen evolution electrode 10 includes a photocatalyst layer 13, a light absorbing layer 12, and a conductive layer 11.

The photocatalyst layer 13 is a layer which is in contact with the electrolytic solution 101 in the oxygen evolution device 100, and is formed of an oxide material which exhibits catalytic activity for oxygen evolution. As the oxide material having high catalytic activity, a metal oxide such as a lanthanum cobalt oxide (LaCoO₃) having a perovskite structure, for example, may be used. A crystal having the perovskite structure is represented by the general formula ATO₃ or A₂TO₄, in which A is lanthanoid or an alkaline earth metal, and T is a transition metal.

An alkaline-earth metal such as Sr, Ca, Ba, Mg, or Be, or a transition metal such as Mn, Ir, or Pd may be added to a perovskite-type oxide such as LaCoO₃. Addition of these elements is optional and the photocatalyst layer 13 is formed of a compound containing at least La, Co, and O. The lanthanum cobalt oxide may deviate from a stoichiometric ratio due to oxygen release and may also be described as LaCoO_{3-δ}. In this specification and the claims, LaCoO₃ is also intended to include LaCoO_{3-δ}. When an element such as Sr or Ca is added to LaCoO₃, LaCoO₃ may deviate from the stoichiometric ratio due to oxygen release by substitution of Sr or Ca, and may be described as La₁₋ₓSrₓCoO_{3-δ} or La₁₋ₓCaₓCoO_{3-δ}.

The light absorbing layer 12 is a layer having an internal depletion layer, and generates carriers excited by absorption of light. When the light absorbing layer 12 is used for the oxygen evolution electrode 10 having the configuration illustrated in FIG. 2, the light absorbing layer 12 is a layer in which an n-type dopant is added to a semiconductor layer such as silicon or is a perovskite-type oxide semiconductor layer in which n-type conductivity is exhibited. When a semiconductor material such as silicon is used as the light absorbing layer 12, P, As, Sb, Bi, or the like may be added. When a perovskite-type oxide semiconductor such as SrTiO is used for the light absorbing layer 12, Nb, La, Hf, Ta, Mo, Ru, Rh, Ir, Gb, Mn, As, Sb, Bi, or the like may be added. As an example, SrTi₁₋ₓNbₓO₃, Sr₁₋ₓLaₓTiO₃, or the like may be used.

The conductive layer 11 functions as a working electrode. A material of the conductive layer 11 is not particularly limited as long as the material is a good conductor inactive to the electrolytic solution 101, and Au, Pt, or the like may be used.

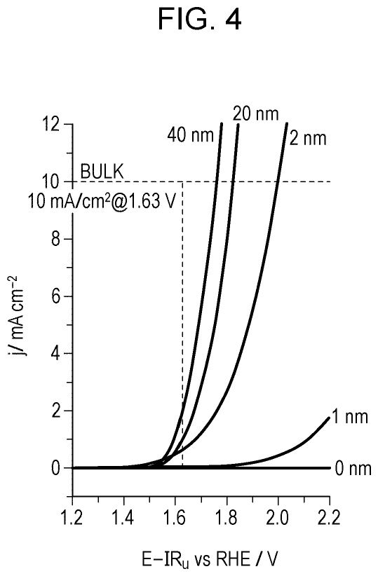

In the configuration illustrated in FIG. 2, it is preferable that the photocatalyst layer 13 is as thin as possible from a viewpoint of shortening a carrier transportation distance. When the photocatalyst layer 13 is at a light incident side, the photocatalyst layer 13 is also desirably as thin as possible from a viewpoint of minimizing absorption of light in the photocatalyst layer 13. However, unlike noble metals such as Ir and Ru, catalytic activity of a perovskite-type metal oxide remarkably decreases when a thickness of the perovskite-type metal oxide is reduced to an atomic layer level. This will be described with reference to FIG. 3 and FIG. 4.

FIG. 3 is a schematic diagram of a sample 10A of the oxygen evolution electrode 10 used for measuring voltage-current characteristics by using the configuration in FIG. 2. La_{0.7}Sr_{0.3}CoO₃ is used as the photocatalyst layer 13, and the voltage-current characteristics are measured by changing a film thickness of La_{0.7}Sr_{0.3}CoO₃. SrTiO to which 1 wt % of Nb is added (NSTO) is used as the light absorbing layer 12. A thickness of the NSTO layer is 500 μm. The conductive layer 11 serving as a working electrode is an Au layer having a thickness of 50 nm.

FIG. 4 illustrates voltage-current curves when a film thickness of the photocatalyst layer 13 is changed in the sample 10A having the configuration illustrated in FIG. 3. The horizontal axis represents a potential (E-IR vs RHE) of the working electrode for a reference electrode (reversible hydrogen electrode (RHE)), and the vertical axis represents a current density j (mA/cm²). As an electrolytic solution, 0.1 M of potassium hydroxide (KOH) solution is used. The potential of the working electrode for the reference electrode is swept at 20 mV/s to measure a response current, and electrolytic solution resistance is corrected. The voltage-current characteristics serve as an indication of the catalytic activity of the oxygen evolution electrode 10.

When the thickness of the La_{0.7}Sr_{0.3}CoO₃ (to be referred to as “LSCO”) photocatalyst layer 13 is 2 nm to 40 nm, the voltage-current characteristics are very good due to catalytic action. In bulk LSCO, a current density of 10 mA/cm² is observed at a potential of 1.63 V, but even with the thin film having the thickness of 2 nm to 40 nm, a current density sharply rises at a potential lower than 2.0 V, so that it is possible to obtain a current density equivalent to that of the bulk.

From this, it is found that the perovskite-type metal oxide effectively functions as a nanoscale thin film photocatalyst. When the photocatalyst layer 13 is formed of a perovskite-type compound thin film containing at least La, Co, and O, good catalytic activity is exhibited within a thickness range of 2 nm to 40 nm. This is considered to be because a uniform and smooth pn junction is formed between the photocatalyst layer 13 and the light absorbing layer 12, and band bending occurs in which diffusion of electrons to a surface of the catalyst is suppressed, so that a high photocurrent value is exhibited.

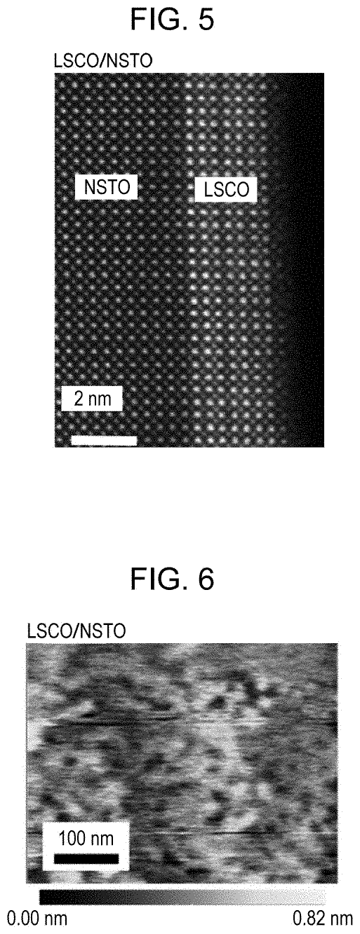

FIG. 5 is a TEM image of a lamination in which LSCO having a thickness of 2 nm is deposited on NSTO in the configuration in FIG. 3, and FIG. 6 is an AFM image of the same structure. It is observed that an atomically uniform, smooth LSCO layer is formed.

On the other hand, when the thickness of the perovskite-type oxide photocatalyst layer 13 is equal to or thinner than 1 nm, the catalytic activity is hardly obtained. It is considered that, in part, the wide depletion layer in the light absorbing layer 12 is too close to a solid-liquid interface, and transportation of charges from a carrier reservoir side doped with high density in the light absorbing layer 12 to the photocatalyst layer 13 is hindered.

When an amount of Nb added to SrTiO₃ is 1 wt %, a width of the depletion layer is about 20 nm, and when the added amount of Nb is 0.01 wt %, the width of the depletion layer is about 100 nm. When the width of the depletion layer is too large in a vicinity of the solid-liquid interface, it becomes difficult to separate carriers which are excited and accumulated in NSTO, toward a surface of the photocatalyst layer 13. Such deterioration in catalytic activity possibly occurs in not only NSTO but also any material inside which a depletion layer extends. For example, even with a light absorber having an indirect band gap such as Si to be used as an optical anode, when the width of the depletion layer is increased in the vicinity of the solid-liquid interface, the catalytic activity is reduced.

With the configuration of the first embodiment, when the thickness of the photocatalyst layer 13 is made to be 2 nm to 40 nm, sufficiently high catalytic activity is achieved, but in the following embodiments, the photocatalyst layer 13 is further thinned.

### Second Embodiment

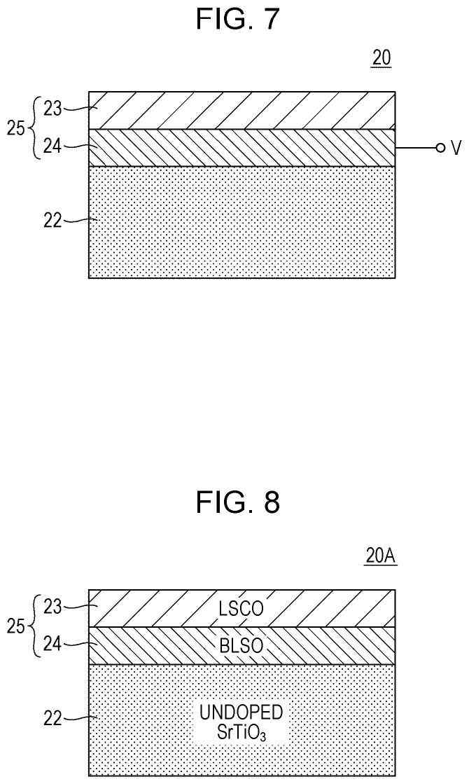

FIG. 7 is a schematic diagram of an oxygen evolution electrode 20 according to the second embodiment. In the second embodiment, a configuration of an oxygen evolution electrode is provided in which OER activity equivalent to those of noble metals may be obtained even when a photocatalyst layer in contact with the electrolytic solution 101 is thinned to an atomic layer level that is less than 2 nm. In order to achieve this, a degenerately doped n-type stannate buffer layer is inserted between a photocatalyst layer and a support substrate which has an internal depletion layer and generates excited carriers by light absorption. By inserting the buffer layer, the excited carriers accumulated at a doped side of the depletion layer in the support substrate may be rapidly transported to a surface of the photocatalyst layer.

The oxygen evolution electrode 20 includes a buffer layer 24 which is degenerately doped between a photocatalyst layer 23 in contact with the electrolytic solution 101 (see FIG. 1), and a support substrate 22.

Similarly to the first embodiment, the photocatalyst layer 23 is formed of an oxide material having high catalytic activity for the electrolytic solution 101. As the oxide material having high catalytic activity, a metal oxide such as a lanthanum cobalt oxide (LaCoO₃) having a perovskite structure, for example, may be used. An alkaline-earth metal such as Sr, Ca, Ba, Mg, or Be, or a transition metal such as Mn, Ir, or Pd may be added to a perovskite-type cobalt oxide such as LaCoO₃. Addition of these elements is optional and the photocatalyst layer 23 is formed of a compound containing at least La, Co, and O.

A difference from the first embodiment is that the photocatalyst layer 23 is laminated over the n-type buffer layer 24 which is degenerately doped, and this laminated body 25 is supported over the support substrate 22. In this specification, the term “over” a layer refers to an upper side in a laminated direction. By inserting the degenerately doped n-type buffer layer 24 between the support substrate 22 and the photocatalyst layer 23, a thickness of the photocatalyst layer 23 may be reduced to 0.5 nm to 20 nm. The buffer layer 24 to be inserted has the thickness of 2 nm to 100 nm, more preferably 3 nm to 100 nm, and still more preferably 3 nm to 50 nm. An optimum film thickness range of the buffer layer will be described later.

The buffer layer 24 is, for example, an oxide semiconductor layer having a perovskite-type crystal structure, and is degenerately doped, so that its Fermi level is close to a conduction band level, and thus the buffer layer 24 has metal-like characteristics. A width of a depletion layer generated inside the buffer layer 24 is sufficiently narrow compared to an internal depletion layer in the support substrate 22. At an interface between the buffer layer 24 and the support substrate 22, a band edge is bent such that the Fermi levels of the buffer layer 24 and the support substrate 22 coincide with each other, and holes excited by a valence band are easily moved from the buffer layer 24 to the photocatalyst layer 23.

The buffer layer 24 having a narrow width of the depletion layer is achieved by, for example, making a perovskite-type stannate be the n-type due to degenerately doping. A relative permittivity of stannate is low, which is about 25, so that the width of the internal depletion layer may be reduced by degenerately adding impurities to stannate having a low permittivity. As stannate, for example, BaSnO₃, SrSnO₃, CaSnO₃, or the like may be used. In this case, examples of stannate to which an element M providing n-type conductivity is added include Ba₁₋ₓMₓSnO₃, Sr₁₋ₓMₓSnO₃, Ca₁₋ₓMₓSnO₃, and the like.

The laminated body 25 of the photocatalyst layer 23 and the buffer layer 24 is supported over a single layer or multilayer. In the example illustrated in FIG. 7, the laminated body 25 of the photocatalyst layer 23 and the buffer layer 24 is disposed over the support substrate 22 having a single layer, but may be disposed over a support body having multilayer. The configuration in which the laminated body 25 is disposed over the support body having multilayer will be described in a third embodiment.

The degenerately doped buffer layer 24 may be used as a working electrode. Alternatively, a conductive film made of Au or the like may be formed on a rear surface of the support substrate 22 to serve as a working electrode.

FIG. 8 is a configuration diagram of a sample 20A for measuring catalytic activity in the oxygen evolution electrode 20 according to the second embodiment. In the sample 20A, LSCO is used as the photocatalyst layer 23, and the thickness thereof is variously changed. The buffer layer 24 is a Ba_{0.97}La_{0.03}SnO₃ (denoted by “BLSO” in the figure) layer having a thickness of 50 nm to which La of 3 at % is added. The support substrate 22 is an undoped SrTiO₃ substrate having a thickness of 0.5 mm.

A BLSO layer having an La addition amount of 3 at % is grown to a thickness of 50 nm over the undoped SrTiO₃ support substrate 22 by a pulsed laser deposition method. The LSCO photocatalyst layer 23 is film-formed over the BLSO buffer layer 24 by changing the film thickness in the range of 0.5 nm to 20 nm to produce a plurality of samples. As a working electrode for measurement, an Au film is formed on the rear surface of the undoped STO support substrate 22.

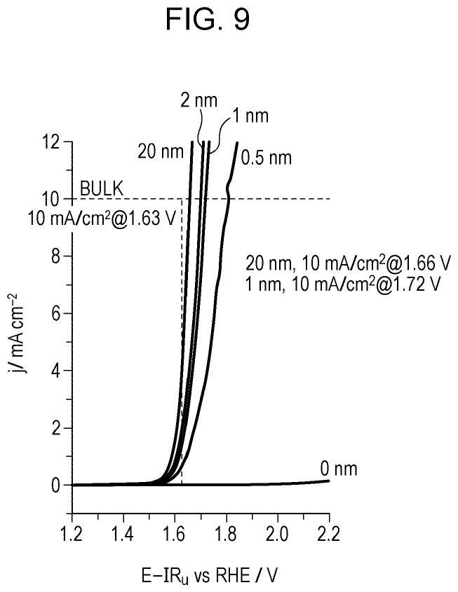

FIG. 9 is measurement results of the sample illustrated in FIG. 8. The horizontal axis represents a potential (E-IR vs RHE) of the working electrode for a reference electrode (reversible hydrogen electrode (RHE)), and the vertical axis represents a current density j (mA/cm²). As the electrolytic solution 101, 0.1 M of potassium hydroxide (KOH) solution is used. The potential of the working electrode for the reference electrode is swept at 20 mV/s to measure a response current, and electrolytic solution resistance is corrected. The voltage-current characteristics serve as an indication of the catalytic activity of the oxygen evolution electrode 20.

Even when the thickness of the LSCO photocatalyst layer 23 is reduced to be 0.5 nm to 20 nm, the voltage-current characteristics are very good due to the catalytic (oxidizing) action. In bulk LSCO, a current density of 10 mA/cm² is observed at a potential of 1.63 V, but even with the thin film having the thickness of 0.5 nm to 20 nm, a current density sharply rises at a potential equal to or lower than 1.8 V, so that it is possible to obtain a current density equivalent to that of the bulk. In particular, in a sample having the thickness of LSCO of 20 nm, the current density of 10 mA/cm² is obtained at the potential of 1.66 V, and the catalytic activity equivalent to that of the bulk is achieved. Even when the film thickness of LSCO is set to 1 nm, the current density of 10 mA/cm² is obtained at the potential of 1.72 V. It is confirmed that the catalytic activity is maintained even when LSCO is made to have the thickness of 0.5 nm, that is, a thin film having a thickness of one unit cell.

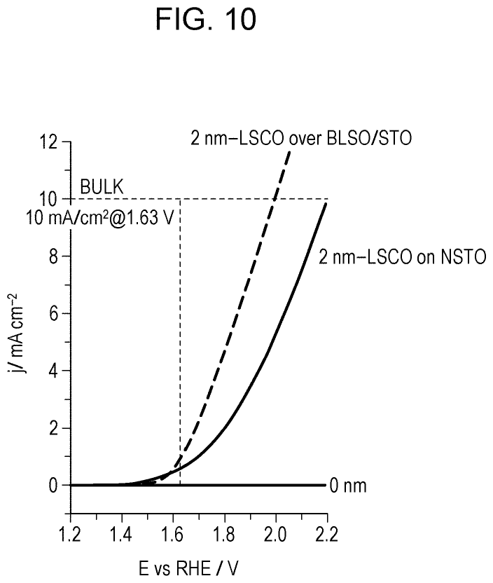

FIG. 10 illustrates a voltage-current curve when an LSCO film having a thickness of 2 nm is formed over a BLSO/STO configuration in the sample illustrated in FIG. 8. As a comparison, a voltage-current curve when the LSCO film having the thickness of 2 nm is directly formed on an Nb-doped STO substrate (“NSTO”) of the first embodiment is illustrated together. In FIG. 10, since series resistance of electrolytic solution resistance and film resistance is not corrected, although the measurement result in FIG. 10 slightly deviates from the measurement results in FIG. 4 and FIG. 9, tendency of the voltage-current curve in FIG. 10 is the same as those in FIG. 4 and FIG. 9.

By inserting the BLSO buffer layer under the LSCO thin film having catalytic action, it is possible to achieve the same degree of activity as the bulk LSCO photocatalyst at a lower potential.

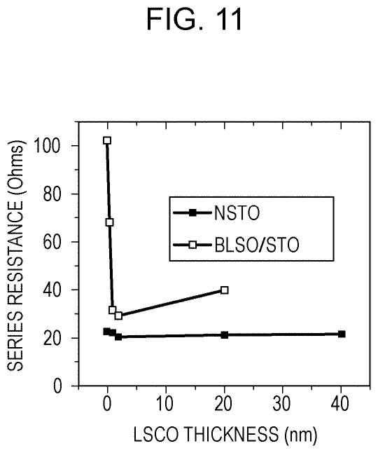

FIG. 11 illustrates series resistance as a function of a thickness of an LSCO photocatalyst layer. A black square mark represents series resistance in the configuration of the first embodiment in which the LSCO film is directly formed on NSTO, and a white square mark represents series resistance in the second embodiment in which the LSCO film is formed over the BLSO buffer layer 24.

In the configuration in which the LSCO photocatalyst layer 13 is directly formed on NSTO as in the first embodiment, the series resistance is almost invariable regardless of change in film thickness of LSCO. However, from a viewpoint of catalytic activity, it is desirable that the film thickness of the LSCO is equal to or larger than 2 nm (see FIG. 4).

As in the second embodiment, in the configuration in which the LSCO photocatalyst layer 23 is formed over STO with the BLSO buffer layer 24 interposed therebetween, the thickness of the LSCO photocatalyst layer 23 is set to 1 to 10 nm, whereby the series resistance may be reduced. More preferably, by setting the thickness of the LSCO photocatalyst layer 23 to 1 to 2 nm, the series resistance may be made close to resistance of a water splitting cell.

From the above, in the configuration in which the photocatalyst layer 23 is formed over the buffer layer 24 which is degenerately n-type doped, the thickness of the photocatalyst layer 23 may be reduced to 0.5 nm to 20 nm in a state where the catalytic activity is maintained high. In view of reduction in series resistance, it is more preferable that the thickness of the photocatalyst layer 23 is 1 nm to 10 nm.

### Third Embodiment

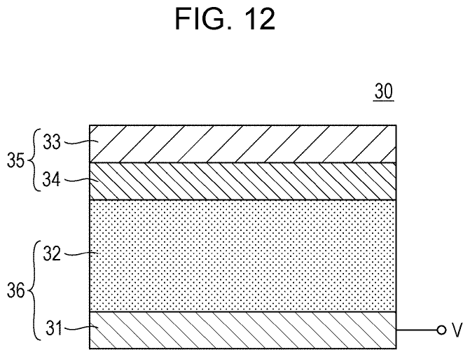

FIG. 12 is a schematic diagram of an oxygen evolution electrode 30 according to the third embodiment. In the third embodiment, a laminated body 35 of a photocatalyst layer 33 and a buffer layer 34 is disposed over a support body 36 having multilayer. The support body 36 having multilayer includes a support substrate 32 and a conductive layer 31 formed on a rear surface of the support substrate 32. The support substrate 32 includes a depletion layer inside and may function as a light absorbing layer. The conductive layer 31 functions as a working electrode.

As in the second embodiment, the degenerately doped n-type stannate buffer layer 34 is inserted between the photocatalyst layer 33 and the support body 36. As a result, a thickness of the photocatalyst layer 33 is reduced to 0.5 nm to 20 nm. Excited carriers generated by light absorption and accumulated at a degenerately doped side of a depletion layer in the support substrate 32 may be rapidly transported to the photocatalyst layer 33.

As in the first embodiment and the second embodiment, the photocatalyst layer 33 is formed of an oxide material having high catalytic activity for the electrolytic solution 101. As the oxide material having high catalytic activity, a metal oxide such as a lanthanum cobalt oxide (LaCoO₃) having a perovskite structure, for example, may be used. An alkaline-earth metal such as Sr, Ca, Ba, Mg, or Be, or a transition metal such as Mn, Ir, or Pd may be added to a perovskite-type cobalt oxide such as LaCoO₃. Addition of these elements is optional and the photocatalyst layer 33 is formed of a compound containing at least La, Co, and O.

The buffer layer 34 is a degenerately doped n-type perovskite-type tin compound layer. A width of an internal depletion layer in the buffer layer 34 is sufficiently narrower than that of the internal depletion layer in the support substrate 32. The degenerately doped n-type tin compound buffer layer 34 is, for example, Ba₁₋ₓLaₓSnO₃, Sr₁₋ₓLaₓSnO₃, Ca₁₋ₓLaₓSnO₃, or the like.

The support substrate 32 supporting the laminated body 35 of the photocatalyst layer 33 and the buffer layer 34 is an n-type doped perovskite-type substrate, for example. As an example, an Nb-doped SrTiO₃ substrate is used. Since the buffer layer 34 having a narrow depletion layer width is inserted between the support substrate 32 and the photocatalyst layer 33 in comparison with the first embodiment, a ratio of dopant added to the support substrate 32 may be made lower than that of dopant added to the light absorbing layer 12 of the first embodiment. As an example, 0.01 wt % of Nb is added.

Since the buffer layer 34 having the narrow depletion layer width is inserted, the excited carriers generated by the light absorption are rapidly transported from a carrier accumulation side of the internal depletion layer in the support substrate 32 to a surface of the photocatalyst layer 33.

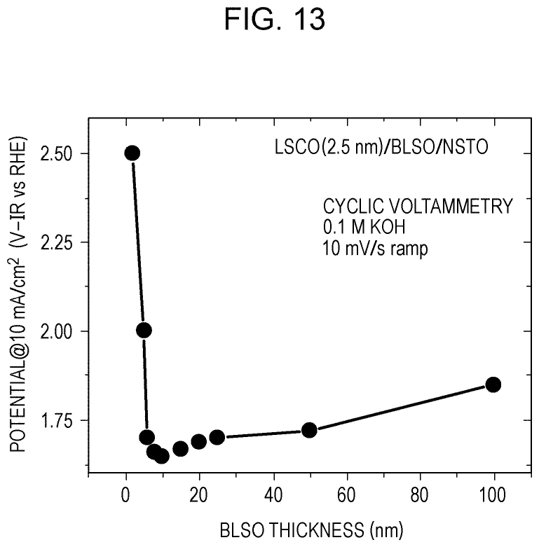

FIG. 13 is a diagram illustrating an optimum film thickness range of the buffer layer 34 in the configuration illustrated in FIG. 12. As a sample for measurement, BLSO is grown with various thicknesses on a surface of a SrTiO₃ (NSTO) substrate having a thickness of 0.5 mm to which 0.01 wt % of Nb is added, and an La_{0.7}Sr_{0.3}CoO₃ (LSCO) thin film having a thickness of 2.5 nm is formed over the BLSO layer. An Au layer having a thickness of 50 nm is formed on a rear surface of the NSTO substrate as a working electrode.

In FIG. 13, the horizontal axis represents the film thickness of BLSO as the buffer layer 34, and the vertical axis represents a potential (V-IR vs RHE) when a current density of 10 mA/cm² is obtained. The potential of the working electrode for an RHE electrode is swept at 10 mV/s by using KOH of 0.1 M as an electrolytic solution, and the potential is recorded when the current density of 10 mA/cm² is obtained. This cyclic voltammetry is performed in a state where no light is incident.

It is desirable that the potential for obtaining the same response current is lower. From the measurement results illustrated in FIG. 13, it is preferable that the film thickness of the BLSO buffer layer 34 is in a range of 2 nm to 100 nm in which a current density of 10 mA/cm² is obtained at a potential equal to or lower than 2.0 V, and it is more preferable that the film thickness is in a range of 3 nm to 100 nm in which the current density of 10 mA/cm² is obtained at a potential lower than 2.0 V. It is still more preferable that the film thickness is in a range of 3 nm to 50 nm in which the current density of 10 mA/cm² is obtained at a potential equal to or lower than 1.75 V.

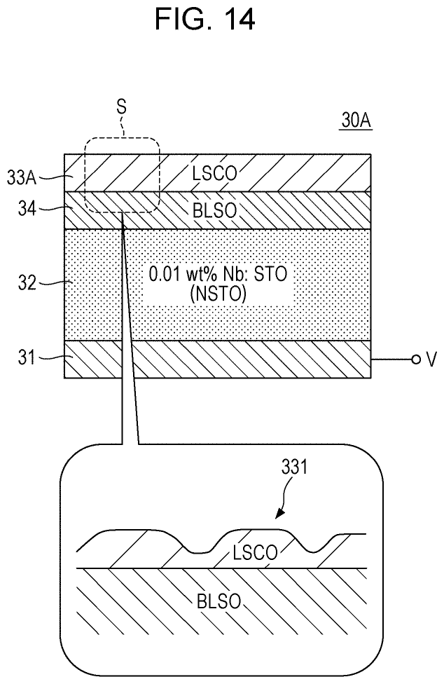

FIG. 14 is a schematic diagram of a sample 30A used in the measurement in FIG. 13. The sample 30A is produced by growing the Ba_{0.97}La_{0.03}SnO₃ (BLSO) buffer layer 34 to a thickness of 10 nm on the surface of the SrTiO₃ (NSTO) support substrate 32 to which 0.01 wt % of Nb is added, and growing an La_{0.7}Sr_{0.3}CoO₃ (LSCO) photocatalyst layer 33A over the buffer layer 34. An Au layer having a thickness of 50 nm is formed as the conductive layer 31 on the rear surface of the NSTO support substrate 32.

In a surface region S of the sample 30A, irregularities (unevenness) or islands 331 are formed in the LSCO photocatalyst layer 33A. An average height of the islands 331 is 2.5 nm.

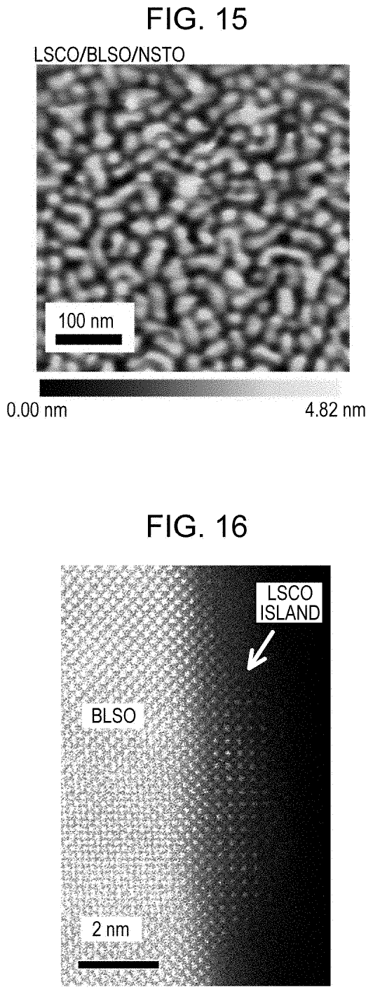

FIG. 15 and FIG. 16 are an AFM image and a TEM image of the configuration illustrated in FIG. 14, respectively. An island structure is observed when LSCO is grown over the BLSO buffer layer 34. Since the island 331 is formed, a contact area between the electrolytic solution 101 and the photocatalyst layer 33 is increased, and the catalytic action for the electrolytic solution 101 may be enhanced. Light may be efficiently incident on the degenerately doped n-type buffer layer 34 and the support substrate 32 from a gap between the island 331 and the island 331 adjacent to each other.

Since the buffer layer 34 having the narrow depletion layer width is disposed between the support substrate 32 and the LSCO photocatalyst layer 33, even when a relatively large depletion layer is spread inside the support substrate 32, holes may be efficiently transported to the surface of the photocatalyst layer 33.

### Fourth Embodiment

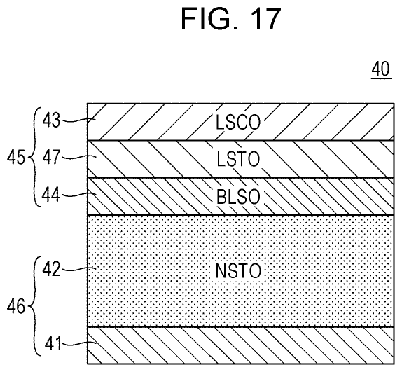

FIG. 17 is a schematic diagram of an oxygen evolution electrode 40 according to the fourth embodiment. In the fourth embodiment, a second buffer layer 47 is inserted between a buffer layer 44 for promoting carrier transportation and a photocatalyst layer 43.

In the third embodiment, the island structure illustrated in FIG. 14 to FIG. 16 is considered to be formed by a lattice mismatch between BLSO that forms the buffer layer 34 and LSCO that forms the photocatalyst layer 33. The island 331 increases the contact area between the photocatalyst layer 33 and the electrolytic solution 101, and allows light to be efficiently incident on the inside of the oxygen evolution electrode 30. However, depending on a film forming process, the structure of the buffer layer 34 may become unstable.

Therefore, in the fourth embodiment, the buffer layer 44 for promoting carrier transportation is stabilized to enhance reliability of the oxygen evolution electrode 40.

The oxygen evolution electrode 40 includes a laminated body 45 in which the degenerately doped n-type stannate buffer layer 44, the degenerately doped n-type second buffer layer 47 and the photocatalyst layer 43 are laminated in this order over a support substrate 42 having an internal depletion layer. A conductive layer 41 is formed on a rear surface of the support substrate 42, and the laminated body 45 is disposed over a support body 46 having multilayer.

The photocatalyst layer 43 is made of an oxide material having high catalytic activity for oxygen evolution, similarly to the first embodiment to the third embodiment, and is thinned to a thickness of 0.5 nm to 20 nm.

As the oxide material having high catalytic activity, a metal oxide such as a lanthanum cobalt oxide (LaCoO₃) having a perovskite structure, for example, may be used. An alkaline earth metal such as Sr, Ca, Ba, Mg, or Be, or a transition metal such as Mn, Ir, or Pd, may be added to a perovskite-type oxide such as LaCoO₃. P-type doping is optional and the photocatalyst layer 33 is formed of a compound containing at least La, Co, and O.

The degenerately doped n-type stannate buffer layer 44 is, for example, Ba₁₋ₓLaₓSnO₃, Sr₁₋ₓLaₓSnO₃, Ca₁₋ₓLaₓSnO₃ or the like. A width of an internal depletion layer in the buffer layer 44 is sufficiently narrower than that of the internal depletion layer in the support substrate 42.

The second buffer layer 47 which is disposed between the photocatalyst layer 43 and the buffer layer 44 ensures lattice matching between the photocatalyst layer 43 and the buffer layer 44. It is preferable that a lattice constant of the second buffer layer 47 is a size between a lattice constant of the buffer layer 44 and a lattice constant of the photocatalyst layer 43.

A material of the second buffer layer 47 is selected according to materials of the buffer layer 44 and the photocatalyst layer 43, and when the BLSO buffer layer 44 and the LSCO photocatalyst layer 43 are used, SrTiO₃ (denoted by “LSTO” in the figure) to which La of 3 at % is added, for example, may be used.

The support substrate 42 supporting the laminated body 45 of the buffer layer 44, the second buffer layer 47, and the photocatalyst layer 43 is a perovskite-type oxide substrate inside which a depletion layer is formed. As an example, a SrTiO₃ substrate doped with 0.01 wt % of Nb is used.

Since the buffer layer 44 having the narrow depletion layer width is inserted, excited carriers generated by light absorption are rapidly transported from a carrier accumulation side of the internal depletion layer in the support substrate 42 to a surface of the photocatalyst layer 43.

Since the second buffer layer 47 is disposed between the buffer layer 44 and the photocatalyst layer 43, crystals of each layer are stably grown in the laminated body 45, and the photocatalyst layer 43 is formed into a uniform and smooth layer.

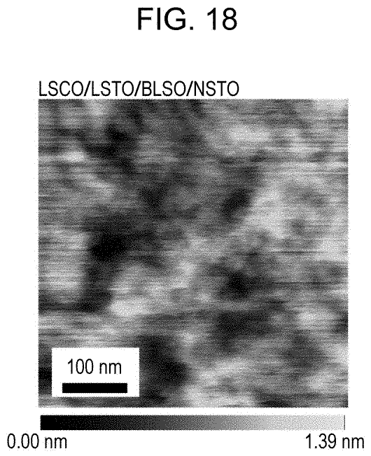

FIG. 18 is an AFM image of the configuration illustrated in FIG. 17. The La_{0.03}Sr_{0.97}TiO₃ second buffer layer 47 is grown to a thickness of 4 nm over the Ba_{0.97}La_{0.03}SnO₃ (BLSO) buffer layer 44 having a thickness of 10 nm, and the LSCO photocatalyst layer 43 having a thickness of 2 nm is film-formed over the second buffer layer 47.

By inserting the second buffer layer 47, layer-by-layer growth is promoted, and the smooth photocatalyst layer 43 is formed. Also in this configuration, reduction in film thickness of the photocatalyst layer 43 and high catalytic activity are achieved.

The thickness of the second buffer layer 47 may be set to a suitable film thickness that may ensure lattice matching between the buffer layer 44 and the photocatalyst layer 43 within a range that does not significantly increase the thickness of the laminated body 45. When the buffer layer 44 is made of Ba₁₋ₓMₓSnO₃, Sr₁₋ₓMₓSnO₃, Ca₁₋ₓMₓSnO₃, or the like, and the photocatalyst layer 43 is a layer made of LaCoO₃ or made by adding one or a plurality of elements selected from Sr, Ca, Ba, Mg, Be, Mn, Ir, and Pd to LaCoO₃, LaSrTiO₃ having a thickness of 1 nm to 20 nm may be inserted as the second buffer layer 47.

While the embodiments have been described based on specific configuration examples, the present disclosure is not limited to the examples described above. As the photoelectrode 1 of the oxygen evolution device 100 in FIG. 1, any one of the oxygen evolution electrodes 10, 20, 30, and 40 according to the first embodiment to the fourth embodiment may be used. In any configuration, the photocatalyst layer in contact with the electrolytic solution 101 may be thinned and may exhibit high catalytic activity. Although the uppermost layer that is in contact with the electrolytic solution 101 and that causes a catalytic reaction to the electrolytic solution 101 has been referred to as a “photocatalyst layer” for convenience, the all layers from the uppermost photocatalyst layer to a layer including an internal depletion layer may be referred to as a “photocatalyst”.

The lanthanum cobalt oxide photocatalyst layer is not limited to LSCO (La₁₋ₓSrₓCoO_{3-δ}), and LaCoO_{3-δ}, La₁₋ₓCaₓCoO_{3-δ} or the like may also be used.

As the degenerately doped n-type stannate buffer layer, Sr₁₋ₓMₓSnO₃, Ca₁₋ₓMₓSnO₃, or the like may be used instead of Ba₁₋ₓLaₓSnO₃.

The layer having the internal depletion layer is not limited to SrTiO₃ doped with Nb, and La, Hf, Ta, Mo, Ru, Rh, Ir, Gb, Mn, As, Sb, Bi, or the like may be added to STO. Alternatively, a layer in which P, As, Sb, Bi, or the like is added to a semiconductor such as silicon (Si) may be used.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An oxygen evolution electrode comprising:
a photocatalyst layer that is formed of a perovskite-type oxide containing at least cobalt (Co), lanthanum (La), and oxygen (O) and that is located at an uppermost layer;
a support body that includes at least a layer in which a depletion layer is formed, and that supports the photocatalyst layer, and
a perovskite-type tin compound buffer layer that is degenerately doped n-type and that is disposed between the photocatalyst layer and the support body.

2. The oxygen evolution electrode according to claim 1, wherein
the photocatalyst layer is successively laminated on the buffer layer, and
the photocatalyst layer has a thickness of 0.5 nm to 20 nm.

3. The oxygen evolution electrode according to claim 1, wherein
the photocatalyst layer is successively laminated on the buffer layer, and
the photocatalyst layer has irregularities or an island structure on a surface of the photocatalyst layer.

4. The oxygen evolution electrode according to claim 1, wherein
the buffer layer has a thickness of 2 to 100 nm.

5. The oxygen evolution electrode according to claim 1, further comprising:
a second buffer layer disposed between the buffer layer and the photocatalyst layer, wherein
the surface of the photocatalyst layer is a flat surface.

6. The oxygen evolution electrode according to claim 1, wherein
the photocatalyst layer is made of LaCoO₃ or is made by adding one or a plurality of elements selected from Sr, Ca, Ba, Mg, Be, Mn, Ir, and Pd to LaCoO₃.

7. The oxygen evolution electrode according to claim 1, wherein
the buffer layer contains Ba₁₋ₓMₓSnO₃, Sr₁₋ₓMₓSnO₃, or Ca₁₋ₓMₓSnO₃.

8. The oxygen evolution electrode according to claim 5, wherein
a lattice constant of the second buffer layer is a value between a lattice constant of the buffer layer and a lattice constant of the photocatalyst layer.

9. The oxygen evolution electrode according to claim 1, wherein
the layer inside which the depletion layer is formed is an n-type doped semiconductor or an n-type doped perovskite-type oxide semiconductor.

10. An oxygen evolution electrode comprising:
an oxide semiconductor layer being a perovskite-type and exhibiting an n-type conductivity type;
a photocatalyst layer that is disposed on a first surface of the oxide semiconductor layer, that is formed of a perovskite-type oxide that contains at least cobalt (Co), lanthanum (La), and oxygen (O), and that has a thickness of 2 nm to 40 nm; and
a conductive layer disposed on a second surface opposite to the first surface of the oxide semiconductor layer.

11. An oxygen evolution device comprising:
an oxygen evolution electrode including
a photocatalyst layer that is formed of a perovskite-type oxide containing at least cobalt (Co), lanthanum (La), and oxygen (O) and that is located at an uppermost layer,
a support body that includes at least a layer inside which a depletion layer is formed, and that supports the photocatalyst layer, and
a perovskite-type tin compound buffer layer that is degenerately doped n-type and that is disposed between the photocatalyst layer and the support body;
a counter electrode disposed opposite to the oxygen evolution electrode; and
an electrolytic solution filling a space between the oxygen evolution electrode and the counter electrode.
